(19) United States
(12) Patent Application Publication
(10) Pub. No.: US 2025/0310719 A1
(43) Pub. Date: Oct. 2, 2025

(54) GEOFENCING SYSTEM FOR WEARABLE DEVICES

(71) Applicant: Brandon Tyler Richey, Marion, IL (US)

(72) Inventor: Brandon Tyler Richey, Marion, IL (US)

(21) Appl. No.: 19/070,241

(22) Filed: Mar. 4, 2025

Related U.S. Application Data
(60) Provisional application No. 63/571,432, filed on Mar. 28, 2024.

(51) Int. Cl. H04W 4/021; G08B 21/18; H04W 4/029

(52) U.S. Cl. CPC H04W 4/021; G08B 21/182; H04W 4/029

(57) ABSTRACT

Wearable electronic devices can be equipped with global positioning system (GPS) location sensors that can be used to determine its latitude and longitude coordinates. The device can include a magnetometer sensor to determine its direction on a digital compass. The device can be used to configure the location of a GPS boundary. The size and shape of the boundary can be configured on either the wearable device or a separate computing device. The wearable device can be either inside of a boundary or outside of a boundary. The boundaries can have assigned priority levels that may determine the information displayed on the device. The device can traverse boundaries of different priority levels that may determine the information displayed on the device. The device's boundary status can be relayed to a server for data processing.

### CROSS-REFERENCE TO RELATED APPLICATION

This application claims the benefit of priority to provisional patent application No. 63/571,432, entitled “Geolocation Boundary Judgment Method”, filed on Mar. 28, 2024, which is incorporated herein by reference.

### TECHNICAL FIELD

The present description relates to wearable devices and their GPS sensor boundary systems.

### BACKGROUND

The vast variety of Global Positioning System (GPS) sensors and related applications has been extended to wearable electronic devices. Many wearable electronic devices include both GPS and magnetometer sensors to provide users with feature-rich GPS and compass applications. Such applications may include displays of latitude and longitude coordinates from the GPS sensors, as well as digital compass readouts using the magnetometer sensors. An extended application of GPS sensors is the concept of geofencing, which typically involves the creation of a logical GPS coordinate boundary. Wearable electronic devices can determine if they are within the confines of a GPS boundary and transmit the result to a server for data processing.

### SUMMARY

The present disclosure provides a geofencing system for wearable devices, including a first wearable electronic device; a GPS boundary configuration; a data server; and a second wearable electronic device.

In some embodiments, the GPS boundary configuration includes a first GPS boundary, a second GPS boundary, and a third GPS boundary.

In some embodiments, the GPS boundary configuration is either low priority, medium priority, or high priority.

In some embodiments, GPS location data of the first wearable electronic device is used to determine if the first wearable electronic device is within a GPS boundary and a first wearable electronic device GPS boundary status is transmitted to the data server.

In some embodiments, a first wearable electronic device GPS boundary status is used to determine if a GPS boundary priority level has increased or decreased; and in accordance with a GPS boundary priority level decrease, sending an alert to one or more devices.

The present disclosure further provides a GPS boundary judgment method, including: determining a wearable electronic device GPS location used to determine the origin point of a GPS boundary; a GPS location used as an origin point for a Dirichlet mathematical boundary model; a wearable electronic device GPS location used as an input to a Dirichlet mathematical equation; and performing a calculation to determine if a wearable electronic device is within a GPS boundary.

In some embodiments, the wearable electronic device GPS boundary calculation further includes: computing a mathematical series calculation to determine convergence or divergence; in accordance with the series calculation result being divergent, sending an alert to one or more devices; in accordance with the series calculation result being convergent, recording the GPS location.

### BRIEF DESCRIPTION OF THE DRAWINGS

Some features of the subject technology are described in the appended claims. In order to explain the subject technology, many embodiments are described in the following figures

FIG. 1 illustrates a perspective view of a wearable electronic device, in accordance with evidence provided in the disclosure.

FIG. 2 illustrates a GPS boundary configuration and detection diagram that uses wearable electronic devices, in accordance with evidence provided in the disclosure.

FIGS. 3-4 illustrate block diagrams of a GPS boundary alert process that uses wearable electronic devices, in accordance with evidence provided in the disclosure.

FIG. 5 illustrates a flow diagram of a GPS boundary configuration and alert process that uses wearable electronic devices, in accordance with evidence provided in the disclosure.

FIG. 6 illustrates a block diagram of an electronic device architecture that implements the aspects described in FIGS. 1-5.

### DETAILED DESCRIPTION OF THE EMBODIMENTS

The detailed description provided in this disclosure is to provide a description of the subject technology and is not representative of the only configuration of the subject technology. The drawings included in this disclosure serve as a part of the detailed description. The detailed description is intended to provide specific details regarding the subject technology. Skilled field professionals will understand that the details provided in this disclosure are not the only applicable uses and configurations for the subject technology. Block diagrams are utilized to describe components to clearly communicate the concepts of the subject technology.

Wearable electronic devices can include components such as a motherboard with a processing unit, random access memory, flash memory, Global Positioning System (GPS) sensors, a battery, and other hardware which are parts of an assembly inside an enclosure. These electronic devices can also include user input devices such as a touch screen, which may also serve as a display for the electronic device. Application software can configure and control the electronic device's touch screen display to indicate the current date and time, provide GPS location data, or execute other applications stored inside the memory of the electronic device.

A wearable electronic device can be attached to a user using a strap secured to the electronic device's enclosure. The electronic device's strap can be interchangeable with other straps of different sizes and/or colors. Wearable electronic devices can be used for GPS tracking purposes once they are secured to a user, and it is useful to use a user's GPS coordinates to determine their location within a virtual GPS boundary.

The subject technology in this disclosure provides a GPS boundary detection algorithm for wearable electronic devices utilizing GPS coordinates read from sensors inside a wearable electronic device. The subject technology described in this disclosure may include GPS boundary calculation methods. The subject technology described in this disclosure provides a method for transmitting GPS location data from a wearable electronic device to a server, for GPS boundary data recording and processing.

Once a user decides to use a wearable electronic device for geofencing purposes, that user can launch an application that activates the components associated with the location sensors. For example, a user can use location sensors to determine their GPS coordinates with a wearable electronic device, determine if a wearable electronic device is within a GPS boundary, and the wearable electronic device can send an alert to the user when the user steps outside of a boundary. In another example, a first user can use location sensors to determine their GPS coordinates with a wearable electronic device, determine if a wearable electronic device is within a GPS boundary, and send an alert to a second user, when the first user steps outside of a boundary, using a wireless transmission from a wearable electronic device.

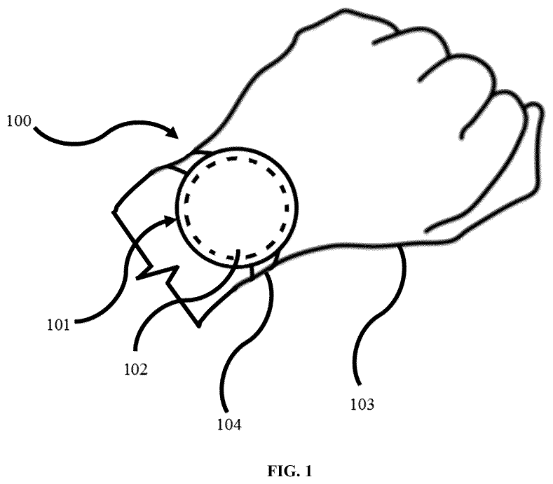

The subject technology is described in detail below with reference to FIGS. 1-6. Those who are skilled in the field will understand that the detailed description, along with its referenced figures, are meant for describing the subject technology, and not limiting the subject technology and its configurations.

FIG. 1 depicts a perspective view of a wearable electronic device that is attached to the body of a user. FIG. 1 shows a wearable electronic device 100 fastened to the wrist of a user 103 with a wristband 104 which can be made from fabric, metal, plastic, and/or other materials. The example in FIG. 1 depicts a wearable electronic device attached to the wrist of a user. However, configurations can take different forms such as a mobile device attached to a user using a wristband 104. For example, a mobile device can be a cellular phone, smart watch, medical device, location tracking device, and/or other electronic device.

FIG. 1 includes an enclosure 101 which contains the internal hardware of a wearable electronic device 100. The enclosure 101 depicted in the example of FIG. 1 is of a round shape, but the enclosure can be of other shapes. The internal hardware of a wearable electronic device can contain microprocessor, biosensor, location sensor, accelerometer, and cellular modem components and/or other electronic components. The wearable electronic device display 102 can include user touch input components which enable the user to interact with the wearable electronic device. The wearable electronic device display 102 may display date and time information for the user and/or other application information. The display 102 may be comprised of an assembly including a liquid crystal display, light emitting diode display, active-matrix organic light-emitting diode display and/or other display technologies. The display 102 may be attached to the top of the enclosure 101 and the wristband 104 may be attached to the enclosure 101 to form a wearable electronic device 100 fastened to the wrist of a user 103.

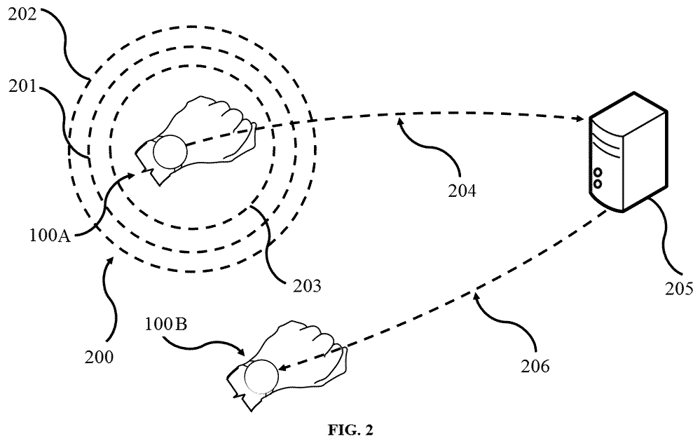

FIG. 2 depicts a GPS boundary configuration 200 and detection diagram that uses a wearable electronic device 100. The example in FIG. 2 depicts a wearable electronic device 100 positioned inside a GPS boundary configuration 200. A GPS boundary configuration 200 can be comprised of a high priority GPS boundary 203, a medium priority GPS boundary 201, and a low priority GPS boundary 202. A high priority GPS boundary 203 can be positioned as an innermost boundary, a medium priority GPS boundary 201 can be positioned as a middlemost boundary, and a low priority GPS boundary 202 can be positioned as an outermost boundary. The example in FIG. 2 depicts a boundary status data transmission 204 for a wearable electronic device 100 that can be transmitted wirelessly to a data server 205. The data server 205 can transmit a boundary status of a first wearable electronic device 100A using a data server boundary status data transmission 206 to a second wearable electronic device 100B. The example in FIG. 2 is not limited and can be changed to configure the GPS boundary priorities and positions to any different combination of GPS boundary priority and position.

In certain examples, a wearable electronic device 100 can either be inside or outside a GPS boundary within a GPS boundary configuration 200. A wearable electronic device 100 can exit a first GPS boundary and enter a second GPS boundary, and a wearable electronic device 100 can exit a second GPS boundary and enter a third GPS boundary. A GPS boundary can be a high priority GPS boundary 203, a medium priority GPS boundary 201, or a low priority GPS boundary 202. When a wearable electronic device 100 enters a GPS boundary, the wearable electronic device 100 can store the boundary level data inside a memory component within the wearable electronic device 100. A GPS boundary configuration 200 can be comprised of overlapping GPS boundaries with high priority GPS boundaries 203, medium priority GPS boundaries 201, and low priority GPS boundaries 202. It is understood that a high priority GPS boundary 203 is of higher ranking than a medium priority GPS boundary 201, and a medium priority GPS boundary 201 is of higher ranking than a low priority GPS boundary 202. The example in FIG. 2 is not limited, and boundaries can use GPS, GNSS, GLONASS and/or other navigation protocols.

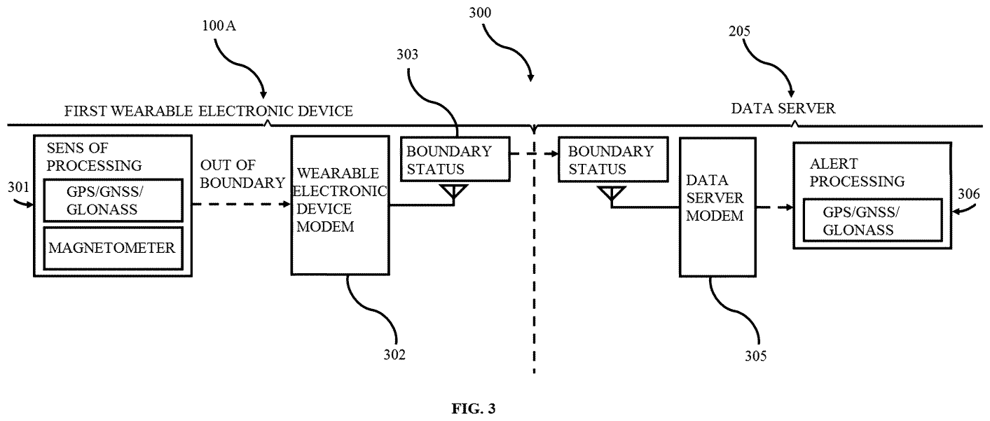

FIG. 3 depicts a block diagram of a GPS boundary alert transmission process 300 that uses wearable electronic devices. The example in FIG. 3 shows a sensor processing component 301 comprising GPS, GNSS, and GLONASS location protocols and magnetometer sensor component that is used for electronic compass applications inside a wearable electronic device 100. An electronic compass can be used to determine the orientation of a wearable electronic device 100 by sensing the earth's magnetic fields. In the event of a wearable electronic device 100 exiting a GPS boundary in accordance with rules established by a GPS boundary configuration 200, a sensor processing component can compute a boundary status and send the data to a wearable electronic device modem 302 inside a wearable electronic device 100. A wearable electronic device modem 302 inside a wearable electronic device 100 can transmit boundary status data 303 to a data server modem 305 inside a data server 205. A data server 205 can use an alert processing component 306 for algorithmic processing of the boundary status data 303. The algorithmic processing of the boundary status data 303 can include determining a first wearable electronic device's 100A associations and sending an alert to an associated second wearable electronic device 100B. The example in FIG. 3 is not limited, and boundary status data 303 can be sent to a wearable electronic device 100 and/or other electronic devices.

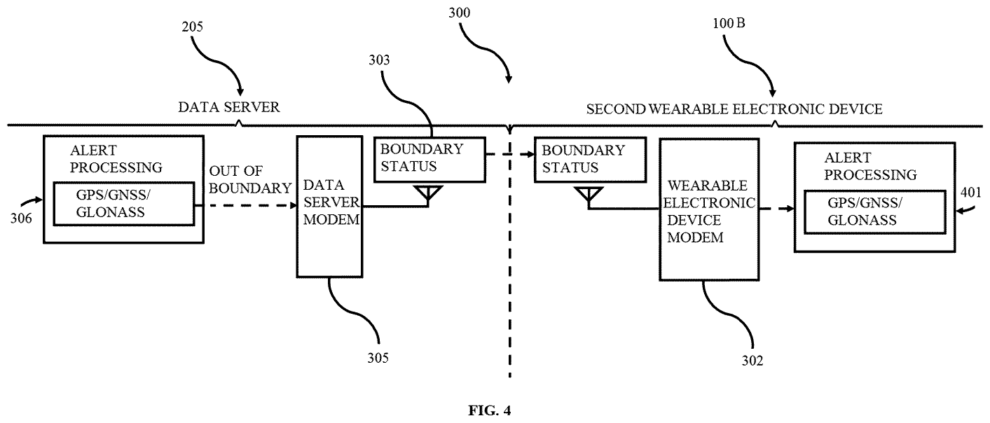

FIG. 4 depicts a block diagram of a GPS boundary alert transmission process 300 that uses wearable electronic devices. The example in FIG. 4 shows a data server 205 comprising an alert processing component 306 that is used for algorithmic processing of boundary status data 303 of a wearable electronic device 100. The boundary status data can be sent from the alert processing component 306 to a data server modem 305 inside a data server 205. The boundary status data 303 can be transmitted to a second wearable electronic device 100B to be received by a wearable electronic device modem 302 inside the second wearable electronic device 100B. The boundary status data 303 of a first wearable electronic device 100A can be received by a second wearable electronic device 100B and sent to an alert processing component 401 inside the second wearable electronic device 100B, which can generate an alert for the user of the second wearable electronic device 100B. It is understood that not only can a boundary status 303 be transmitted to a wearable electronic device 100, but also GPS, GNSS, and/or GLONASS coordinate data of a wearable electronic device 100 be transmitted also. A boundary status alert can be comprised of audible sounds, graphics, and/or other user interface elements displayed on the display 102 of a wearable electronic device 100. The example in FIG. 4 is not limited, and boundary status data 303 can be sent to a wearable electronic device 100 and/or other electronic devices. The data server alert processing component 306 and wearable electronic device alert processing component 401 can be comprised of electronic hardware and/or software.

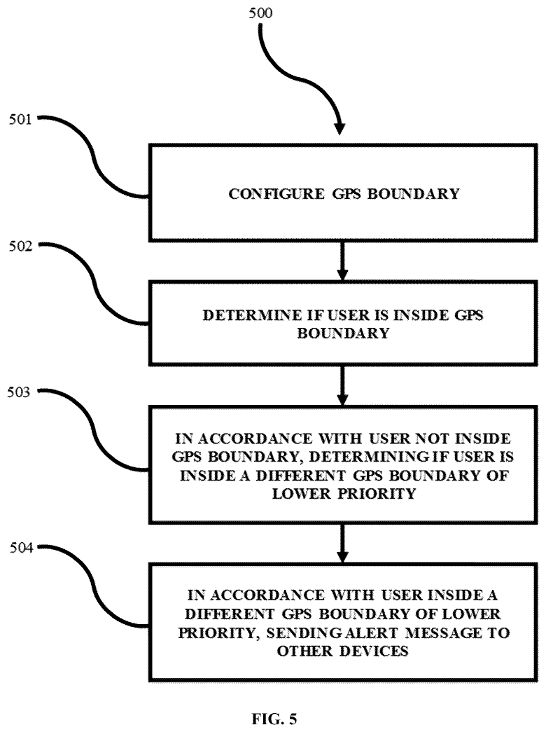

FIG. 5 depicts a flow diagram of a GPS boundary configuration and alert processing method 500 that uses wearable electronic devices. The example in FIG. 5 shows a method that can be used to configure a GPS boundary and process alerts using a wearable electronic device 100. A GPS boundary configuration and alert processing algorithm can be used to create GPS boundaries and determine whether a wearable electronic device 100 is within GPS boundaries. The GPS boundary configuration and alert processing method 500 depicted in example FIG. 5 is not restrictive and can be applied to electronic devices such as cellular phones, tablet computers, smart watches, fitness trackers, medical devices and/or other electronic devices.

In certain examples, a GPS boundary is configured 501 using Dirichlet's mathematical principles. A circular GPS boundary's dimensions can be calculated using the Laplace's equation, uₓₓ+u_{yy}=0, inside a boundary ƒ(θ)=u(a, θ). The rectangular coordinate Laplacian equation, uₓₓ+u_{yy}=0, can be translated to the polar coordinate form

$${u}_{rr} + \frac{1}{r} {u}_{r} + \frac{1}{{r}^{2}} {u}_{θ θ} = 0 .$$

A circular GPS boundary can be configured using the function

$$u ( r , θ ) = \frac{1}{4} + {\sum }_{n = 1}^{20} {( \frac{r}{a} )}^{n} \{ - \frac{1}{n π} [ c o s ( n π ) - 1 ] sin ( n θ ) \} ,$$

where a is the boundary's radius and θ is the angle between a ray r and the circular boundary's east-west coordinate plane axis. A series summation can be used to set the precision of a circular GPS boundary calculation.

A circular GPS boundary can be placed at any point on the world map. A circular boundary can be translated from a point of origin on the world map, using the intersection between north, south, east, and west as a point of origin. The distance between the point of origin and the new translated origin point is ρ, and the angle between the east-west coordinate plane axis and the translated origin point is α. The GPS boundary's translated center point (x′, y′) and the distance formula, ρ=\sqrt{x′²+y′²}, can be used to achieve the function

$$u ( {r}^{′} , {θ}^{′} ) = \frac{1}{4} + {\sum }_{n = 1}^{20} {( \frac{( {r}^{′} + ρ )}{a} )}^{n} \{ - \frac{1}{n π} [ c o s ( n π ) - 1 ] sin ( n ( {θ}^{′} - a ) ) \} ,$$

which can be used to describe a circular boundary translated to a specific position on the world map. It is understood that a circular GPS boundary can be placed at an origin point using either true north or magnetic north. The angle θ can be determined using a magnetometer component inside a wearable electronic device 100.

A quadrilateral GPS boundary's dimensions can be calculated using the Laplace's equation, uₓₓ+u_{yy}=0, inside a boundary's top side described using the function u(x, b)=0, a boundary's left side described using the function u(0, y)=0, a boundary's right side described using the function u(a, b)=ƒ(y), and a boundary's bottom side using the function u(x, 0)=0. A quadrilateral boundary can have a width of a and length of b to create a coordinate point (a, b). Using Laplace's equation, uₓₓ+u_{yy}=0, and each boundary side function we can achieve the function

$$u ( x , y ) = {\sum }_{n = 1}^{20} - \frac{{b}^{2} c o s ( n π )}{n π sin h ( \frac{n π a}{b} )} sin h ( \frac{n π x}{b} ) sin ( \frac{n π y}{b} ) ,$$

which can be used to describe a quadrilateral boundary. A series summation can be used to set the precision of a quadrilateral GPS boundary calculation.

A quadrilateral GPS boundary can be placed at any point on the world map. A quadrilateral boundary can be translated from a point of origin on the world map, using the intersection between north, south, east, and west as a point of origin. The result of this translation will place a quadrilateral GPS boundary in a specified area on the world map. The quadrilateral GPS boundary can be rotated at an angle θ on an axis and its translated coordinate point can be (a′, b′). The function

$$u ( {x}^{′} , {y}^{′} ) = {\sum }_{n = 1}^{20} - \frac{{{b}^{′}}^{2} c o s ( n π )}{n π sin h ( \frac{n π {a}^{′}}{{b}^{′}} )} sin h ( \frac{n π ( x - {x}^{′} )}{{b}^{′}} ) sin ( \frac{n π ( y - {x}^{′} )}{{b}^{′}} ) + {y}^{′}$$

can be used to describe a quadrilateral boundary translated to a specific position on the world map. It is understood that a quadrilateral GPS boundary can be placed at an origin point using either true north or magnetic north. The angle θ can be determined using a magnetometer component inside a wearable electronic device 100.

The GPS boundary configuration and alert processing method 500 can determine if a user with a wearable electronic device 100 is within a specific GPS boundary 502 using the result of the GPS boundary calculations. A GPS boundary calculation result can be compared to a judgment threshold to determine if a user is within a specific GPS boundary. A user can be inside a first GPS boundary and exit the first GPS boundary and enter a second GPS boundary 503, if the second GPS boundary is the same priority level or higher priority level than the first GPS boundary, no alert is sent to the user's wearable electronic device 100. If the second GPS boundary is of lower priority level than the first GPS boundary's priority level, an alert is sent 504 to the user's wearable electronic device 100 and/or other electronic devices. The example in FIG. 5 is not restrictive and circular GPS boundaries can be mixed with quadrilateral GPS boundaries and/or other GPS boundary shapes within a GPS boundary configuration 200. It is understood that GPS boundaries can be configured on a wearable electronic device 100, data server 205, cellular phone, tablet computer and/or other electronic device.

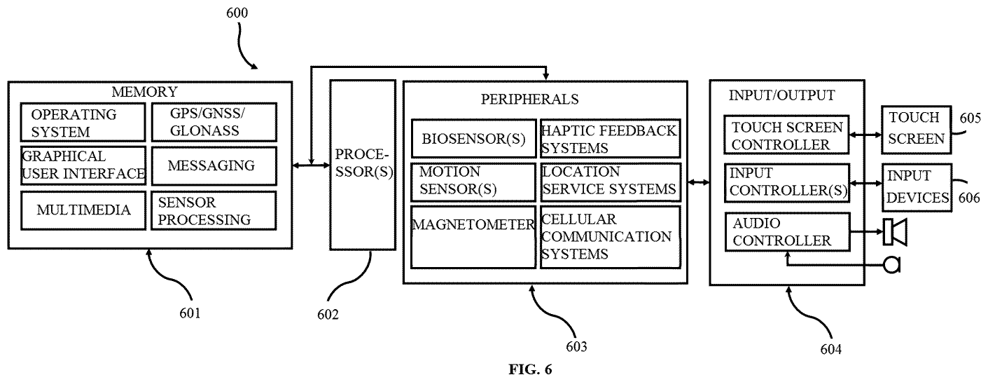

FIG. 6 depicts a block diagram of an electronic device architecture 600 that includes components that can be found on a wearable electronic device 100. The example in FIG. 6 shows an electronic device architecture 600 comprising memory 601, processor 602, peripheral 603, input/output 604, touch screen 605, and input device 606 components which can be used to implement a GPS boundary detection method for a wearable electronic device 100. The example in FIG. 6 is not restrictive, and an electronic device architecture 600 can include memory 601, processor 602, peripheral 603, input/output 604, touch screen 605, and input device 606 components and/or other components.

In certain examples, a memory 601 component of an electronic device architecture 600 can be used to store and execute instructions for operating system, navigation, graphical user interface, messaging, multimedia, sensor processing applications and/or other applications. A memory 601 component can store location tracking application instructions to perform GPS coordinate tracking. A wearable electronic device 100 can display GPS coordinate and/or other location information to a user with an operating system using a graphical user interface running from a memory 601 component. A wearable electronic device 100 can execute multimedia instructions running from a memory 601 component to communicate GPS coordinate and/or GPS boundary data to a user with graphics and sound. Messaging application instructions running from a memory 601 component can be executed to send alerts to a wearable electronic device 100 or other electronic device from one user to another, which can be GPS location alerts and/or other alerts. The example in FIG. 6 is not restrictive and a memory 601 module can be comprised of a read-only memory (ROM) and/or random-access memory (RAM).

A processor 602 component can be used to perform computations for operating system, GNSS/navigation, graphical user interface, multimedia, messaging, and sensor processing applications found in a memory 601 component of a wearable electronic device 100. A processor 602 component can be used to perform computations for biosensor, motion sensor, magnetometer, haptic feedback, location service, and cellular communications peripherals 603 found inside a wearable electronic device 100. The example in FIG. 6 is not restrictive and a processor 602 component can be comprised of a main processor and/or other processors.

Peripherals 603 of an electronic device architecture 600 can be comprised of biosensor, motion sensor, magnetometer, haptic feedback, location service, and cellular communications peripherals and/or other peripherals. Biosensor peripheral(s) can be used to perform user heart rate, blood oxygen, blood pressure, respiratory rate, blood sugar and skin temperature biosensor measurements and/or other biosensor measurements. Motion sensor peripheral(s) can be used to detect acceleration and/or deceleration of a wearable electronic device 100. Magnetometer peripheral(s) can be used to detect magnetic fields that are exposed to a wearable electronic device 100. Haptic feedback peripheral(s) can be used to activate and/or deactivate feedback motors inside a wearable electronic device 100. Location service peripheral(s) can be used to determine the geographical location of a wearable electronic device 100. Cellular communication peripheral(s) can be used to enable a wearable electronic device 100 to connect to cellular networks. The example in FIG. 6 is not restrictive and peripherals 603 can be comprised of biosensor, motion sensor, magnetometer, haptic feedback, location service, and cellular communications peripherals and/or other peripherals.

Input/output (I/O) 604 components of a wearable electronic device 100 can be comprised of touch screen controller(s), input controller(s), audio controller(s) and/or other I/O devices. A touch screen controller can be used to enable a user to interact with a wearable electronic device display 102 with the use of a connected touch screen 605. An input controller can be used to enable a user to connect pushbutton switches, dials and/or other input devices 606 mounted on a wearable electronic device 100. An audio controller can be used to connect speakers, microphones and/or other audio devices. The example in FIG. 6 is not restrictive and I/O 604 components can be comprised of touch screen controller(s), input controller(s), audio controller(s) and/or other I/O devices.

The title, background, brief description of the drawings, abstract, and drawings included in this disclosure are to provide examples and illustrations of the subject technology and are not restrictive descriptions. The examples in this disclosure that contain combined elements are not to be restricted to the single combination of elements presented. The claims are incorporated into the detailed description for each individual subject matter separately. The claims are not limited to the described subject matter but are to adhere to a scope consistent with all legal equivalent language. The claims in this disclosure are not intended to include subject matter that does not meet the requirements of applicable patent law and should not be interpreted in this manner.

What is claimed is:

1. A geofencing system for wearable devices, comprising: a first wearable electronic device; a GPS boundary configuration; a data server; and a second wearable electronic device.

2. The geofencing system for wearable devices of claim 1, wherein the GPS boundary configuration comprises a first GPS boundary, a second GPS boundary, and a third GPS boundary.

3. The geofencing system for wearable devices of claim 1, wherein the GPS boundary configuration is either low priority, medium priority, or high priority.

4. The geofencing system for wearable devices of claim 1, wherein GPS location data of the first wearable electronic device is used to determine if the first wearable electronic device is within a GPS boundary and a first wearable electronic device GPS boundary status is transmitted to the data server.

5. The geofencing system for wearable devices of claim 1, wherein a first wearable electronic device GPS boundary status is used to determine if a GPS boundary priority level has increased or decreased; and in accordance with a GPS boundary priority level decrease, sending an alert to one or more devices.

6. A GPS boundary judgment method, comprising: determining a wearable electronic device GPS location used to determine the origin point of a GPS boundary; a GPS location used as an origin point for a Dirichlet mathematical boundary model; a wearable electronic device GPS location used as an input to a Dirichlet mathematical equation; and performing a calculation to determine if a wearable electronic device is within a GPS boundary.

7. The GPS boundary judgment method of claim 6, wherein the wearable electronic device GPS boundary calculation further comprises: computing a mathematical series calculation to determine convergence or divergence; in accordance with the series calculation result being divergent, sending an alert to one or more devices; in accordance with the series calculation result being convergent, recording the GPS location.
